(19) United States
(12) Patent Application Publication
(10) Pub. No.: US 2026/0326491 A1
(43) Pub. Date: Oct. 22, 2026

(54) AXLE STRUCTURE FOR A UTILITY VEHICLE CHASSIS, COMPRISING AN AXLE BRIDGE

(71) Applicants: Abdullah JABER, Aachen (DE); Raid MAZYEK, Stolberg (DE); Johann FROLIKOW, Dinklage (DE); Andreas KRÖGER, Lohne (DE); Dietrich NOWAK, Dinklage (DE); Trailer Dynamics GMBH, Eschweiler (DE)

(72) Inventors: Abdullah JABER, Aachen (DE); Raid MAZYEK, Stolberg (DE); Johann FROLIKOW, Dinklage (DE); Andreas KRÖGER, Lohne (DE); Dietrich NOWAK, Dinklage (DE)

(73) Assignee: Trailer Dynamics GMBH, Eschweiler (DE)

(21) Appl. No.: 19/109,832

(22) PCT Filed: Sep. 7, 2023
(86) PCT No.: PCT/EP2023/074624

§ 371 Date: Mar. 7, 2025

(30) Foreign Application Priority Data
Sep. 9, 2022 (DE) 10 2022 123 034.1

(51) Int. Cl. B60G 7/02; B60B 35/00

(52) U.S. Cl. CPC B60G 7/02; B60B 35/002; B60G 2200/342; B60G 2202/152; B60G 2204/143; B60G 2204/421; B60G 2300/042

(57) ABSTRACT

An axle structure (6) for a utility vehicle chassis, includes control arms (8), each of which has a pivot bearing (10) at a first end, an interface (18) at a first distance to the pivot bearing (10) for attaching a wheel carrier (12) to the respective control arm (8), and a support section (20) at a second distance to the pivot bearing (10) for connecting the respective control arm (8) to a spring element (14). The aim of the invention is to provide an axle structure which leaves sufficient installation space to provide the utility vehicle with an electric drive in the region of the axle structure. This is achieved in that the control arms (8) are connected together via an axle bridge (22) on the wheel axle (R) side facing away from the pivot bearings (10), said axle bridge (22) being screwed to the control arms (8).

The present invention relates to an axle structure for a commercial vehicle chassis according to the preamble of claim 1 and to a commercial vehicle comprising a corresponding axle structure according to the preamble of claim 16.

Document DE 101 63 628 A1 discloses an axle structure of the type in question comprising an axle bridge. The wheels are driven via a drive motor arranged on the wheel. The axle bridge is arranged beneath the wheel axis, in order to allow a low-floor bus to be boarded as low down as possible.

Document DE 35 26 272 A1 discloses an axle structure in which a hollow axle carrier holds the wheel carriers at its outer ends. The spring and damping elements are supported against the wheel carriers. The axle carrier is in the form of a welded sheet-metal box.

The wheel suspension systems are intended to ensure safe driving behavior and alleviate drops in driving comfort owing to unevennesses on a roadway. In addition, they have to resiliently guide the wheels in the event of jolts without noticeably changing the chassis geometry and at the same time have a spring travel that is as long as possible, damp vibrations and be as lightweight as possible, in order to keep the unsprung masses as low as possible. This applies also to commercial vehicles in the form of truck trailers in the same way as it does for passenger cars.

Recent times have additionally seen the emergence of the problem that an axle structure intended for commercial vehicles should open up the possibility of using one or more electric motors to drive the wheels held by the axle structure. Here, however, there is the problem of the structural space available in a commercial vehicle being limited, in particular if the commercial vehicle is a truck trailer. The structural width and height of a commercial vehicle is already restricted by legal authorization requirements. The wheels used in a commercial vehicle must have a wheel diameter and a wheel width large enough to be able to safely support the mass of the commercial vehicle including its load on the ground. The width of the wheels and of the link arms already considerably restricts the structural space still available therebetween. The commercial vehicle must also downwardly have a sufficient ground clearance. The loading area of the commercial vehicle cannot be raised because otherwise cargo space would be lost, and that would adversely affect the efficiency of the commercial vehicle. The axle systems known from the prior art are for these reasons not suitable for use in conjunction with an electric drive. In particular the customary rigid axles therefore cannot be fitted in such an axle structure.

The object of the present invention is to provide an axle structure which leaves enough structural space to provide the commercial vehicle with an electric drive in the region of the axle structure and which at the same time enables safe driving behavior and a high level of driving comfort.

The object is achieved for the axle structure of the type in question by the characterizing features of claim 1 and for the commercial vehicle of the type in question by the characterizing features of claim 15.

By arranging the axle bridge in the space on that side of the wheel axis that faces away from the pivot bearings, the structural space in the region of the wheel axis between the link arms remains free. An axle tube that reaches from one wheel to the other and directly connects the axes of rotation of the wheels to one another can be omitted. The structural space freed up in this way can then be utilized for drive components of an electric drive for the wheels held by the axle structure. The two link arms are nevertheless connected to one another by the axis bridge.

The link arms are each pivotably mounted in a pivot bearing, which is arranged in a holding device on the frame. By connecting the link arms to one another via the axis bridge, in particular in the region of the link arm portions which are on that side of the wheel axis that faces away from the pivot bearings, the result is better toe management for the wheels fastened to the wheel carriers. The two link arms, together with the axle bridge, form a U-shaped swing arm, on opposite sides of which the two wheels are held. Via the axle bridge, transverse forces acting on the axle structure when the commercial vehicle is being driven are distributed well between the two wheels and link arms. The axle bridge reduces the tendency of the link arms to oscillate transversely to the direction of travel when transverse forces act on one or both link arms. Introducing the axle bridge also ensures a consistent toe width of the axle, this normally being ensured by the rigid axle tube.

The link arms may be formed in one or more parts. In a one-part embodiment, they extend, in the form of a welded assembly or a single component cast from a steel casting, from the pivot bearing into the region of attachment of the axle bridge. In a multi-part embodiment, there are divisions between the individual parts of the link arms, at which divisions the individual parts are, however, joined together to form a link arm.

The axle bridge is designed such that it allows unilateral deflection or rebounding of a control arm on one side of the vehicle without at the same time pulling the link arm that is on the other side of the vehicle upward in the same way or pushing it downward in the same way. Although the axle bridge preferably has a rigid structure, it—and also the link arms—can perform torsional movements to a small extent in the event of unilaterally acting loads, with the result that the acting forces are at least partially compensated. Unilateral deflection or rebounding remains possible as a result. This is the case in particular when the bearing bushes of the pivot bearings in which the link arms are held in a holding device on the frame after they have been installed in a commercial vehicle are soft.

The axle bridge is screwed to the link arms. Owing to the offset of the axle bridge with respect to the wheel axis, admittedly high forces act on the axle bridge specifically in the case of a commercial vehicle, such as a fully laden truck trailer, in order to guide the wheels in particular when cornering. This is all the more the case if the wheels held and guided by the axle structure are additionally still driven and the axle structure has to transmit the drive forces into the frame of the commercial vehicle. It has, however, been found that a screwed connection is also suitable for withstanding the forces that arise at the transition between the link arms and the axle bridge and guiding the link arms safely.

According to one configuration of the invention, the outer ends of the axle bridge have two plates which are spaced apart from one another and, when the axle structure has been mounted on a vehicle, are oriented at least approximately horizontally, wherein between the two plates there is at least one sleeve, the longitudinal center axis of which, when the axle structure has been installed in a vehicle, extends in an at least approximately vertical direction, at least one of the two plates having, in the continuation of the longitudinal center axis of the sleeve, a passage opening through which a threaded bolt that fits into the sleeve is guided, formed between the two plates and one end of the sleeve is an intermediate space in which a connecting element of a link arm is inserted, the connecting element of the link arm also having, in the continuation of the longitudinal center axis of the sleeve, a passage opening through which the threaded bolt that fits into the sleeve is guided, and at least that side of one of the two plates that faces away from the sleeve has a clamping surface against which a threaded nut or a head of the threaded bolt is screwed. The above-described structure makes it possible for the axle bridge and the link arms to be fixedly connected to one another easily, specifically in particular by an advantageous screwed connection, which allows the components to be separately mounted with and dismounted from one another. The sleeve may be in the form of a simple clamping sleeve or of a threaded sleeve with an internal thread. The sleeve can be fixedly connected to a plate, for example by a welded connection, and the screw connection then takes place against the other plate, or the sleeve is inserted, as a simple spacer sleeve, onto a threaded bolt which braces the two plates against one another. The connecting element of the link arm may be a flat limb of the link arm, which has been inserted into the intermediate space between the sleeve and the second plate and then has been screwed to the axle bridge by the threaded bolt inserted through the passage opening. Of course, it is possible for more than one sleeve with a number of passage openings corresponding to the number of sleeves used to be present at the ends of the axle bridge, such that the link arm associated with one end of the axle bridge can be connected thereto via multiple threaded bolts. When the link arm is connected to the axle bridge by multiple threaded bolts, a sufficiently fixed, durable and maintenance-free connection of the two components to one another can be provided. The at least approximately horizontal orientation of the plates depends on the ground clearance of the axle structure, but in the normal, lowered driving state the spatial position of the plates is at least approximately vertical.

According to one configuration of the invention, the axle bridge is in the form of a welded structure and the plates are outwardly facing extensions of the upper and lower profile limbs, in particular of the base plate and of the cover plate, of the axle bridge. The axle bridge may be in the form of a welded structure which on its underside has a base plate, which extends across the width of the axle bridge in an at least approximately constant plane and has a greater overall height in its central portion than in the outer peripheral regions. The welded structure may be relatively lightweight. A corresponding form—for example a hollow box—nonetheless results in a high stiffness. Since the ends of the welded bridge are subjected in particular to compressive or tensile loading in the region of connection to the link arms, a good force flow is generated between the axle bridge and the link arms if the plates are outwardly facing extensions of the upper and lower profile limbs of the axle bridge. It is thus possible for use to be made, as upper and lower profile limbs of the axle bridge, as base plate and cover plate, of steel plates which are fitted in an at least approximately horizontal spatial position in the axle bridge and have a high toughness in the at least approximately horizontal loading direction. If the profile limbs transition into the end plates integrally owing to a corresponding formation, there is no deflection of forces from the plates to the axle bridge. The plates can, however, also be fixedly welded in the respective region of abutment against an upper or lower profile limb to that limb.

According to one configuration of the invention, the plates, when viewed from above, have their longitudinal center axes angled toward the wheel axis in comparison with the longitudinal center axis of the rest of the axle bridge. In this way, the plates each form a type of arch, which extends from the axle bridge in the direction of the wheel axis. Since the arch nonetheless only encompasses the periphery of the structural space between the link arms and the axial bridge, as a result it does not substantially narrow the structural space between the link arms in the region of the wheels, this structural space having become free for drive components of the electric drive owing to the offset of the axle bridge. The end faces of the plates do not need to face toward the wheel axis exactly; they may also be merely approximately inclined in that direction. The arrangement and the orientation of the plates with their arcuate shape corresponds to the path of forces between the axle bridge and the link arms better than an exactly right-angled orientation and attachment of the components does.

According to one configuration of the invention, the axle bridge at its outer ends has a respective fastener for connection to an air-spring bellows. The air-spring bellows is a spring element via which the free end of a link arm can be supported against the vehicle frame. During spring movements of the link arm, the air-spring bellows is compressed or expanded. In the case of a direct connection of the axle bridge to an air-spring bellows, the axle bridge on the corresponding side of the vehicle directly follows the deflection and rebounding movements of this air-spring bellows. Special force transmitting devices can be omitted as a result. The fastener may consist for example of a threaded sleeve or a threaded bolt, via which the components can be connected to one another by a screwed connection. According to one configuration of the invention, the air-spring bellows can also be directly connected only to the axle bridge and not to a link arm, with the result that the spring forces are transmitted only indirectly via the axle bridge to the associated link arm.

According to one configuration of the invention, a corresponding end of the axle bridge is connected both to the link arm and to the air-spring bellows at a connection node. The connection node connects a corresponding end of the axle bridge, of the associated link arm and of the associated air-spring bellows to one another. The connection node makes it possible to easily transmit the acting forces between the components that are connected to one another via the connection node.

According to one configuration of the invention, a bellows carrier has been placed on the upper of the two plates that are located at one end of the axle bridge and has been fixedly connected to the axle bridge. The bellows carrier can be in the form of a plate. The bellows carrier may be provided with openings, through which one or more threaded-bolt heads or threaded nuts that are located therebeneath can be reached. The bellows carrier can be made thick enough that the bolt heads or the threaded nuts cannot protrude beyond the surface of the bellows carrier. This provides a planar surface and sufficient structural space for mounting the spring element, in particular in the form of an air-spring bellows. The connection of the bellows carrier to the axle bridge can be established for example via a screwed or welded connection. Introducing the bellows carrier makes it possible to limit the use of material at the required connection site and avoid a higher component thickness over the entire length of the axle bridge or a complex reworking of the components.

According to one configuration of the invention, the connection between the axle bridge and the link arm is configured such that it is possible to mount a spring element on at least one of these elements without needing to detach the connection between the axle bridge and the link arm. This is made possible by separate interfaces for the connection of the axle bridge and the respective link arm and for the connection between the axle bridge and/or the link arm and the spring element, for example via the bellows carrier. This makes it possible to perform repair on or replace the spring element without excessive outlay.

According to one configuration of the invention, the axle bridge is in the form of a welded structure which on its underside has a base plate, which extends across the width of the axle bridge in an at least approximately constant plane and has a greater overall height in its central portion than in the outer peripheral regions. The at least approximately flat base plate forms a protective device toward the ground for the drive components that may be arranged between the link arms in the shadow of the axle bridge. In the installed state, the base plate defines the ground clearance of the axle structure. In the case of an at least approximately horizontal orientation of the base plate when the axle structure has been installed in the vehicle, if a foreign body strikes the base plate in the direction of extent, the base plate has a high resistance available that considerably reduces the risk of permanent deformations of the axle structure during use. The greater overall height in the central portion increases the strength of the axle bridge statically in the region in which sagging is most likely to occur. Increasing the cross-sectional profile of the axle bridge upwardly means that the available structural space between the link arms is handily utilized.

A fastening bracket for attaching suspension struts is formed in the central region of the axle bridge. The suspension struts make it possible to set the toe, camber, inclination and caster. The toe describes the length difference by which the two wheels of an axle are closer together at the front than at the rear. If the wheels are closer together at the front, this is referred to as “positive toe” or “toe in”, the reverse of “negative toe” or “toe out”. The camber in turn describes the angle of the wheel plane to a perpendicular established in the contact patch of the wheel in question, transverse to the vehicle longitudinal axis. On the other hand, the inclination is the angle between the oblique axle and a perpendicular to the roadway transverse to the vehicle longitudinal axis.

The payload can also, given an unsuitable design of the axle geometry, result in a change in the camber angle. It is thus possible, as a result of the suspension struts, to adapt the camber as appropriate to the payload usually transported. Cornering forces can, when the tire is running, only arise when there is a slip angle and/or camber. As a result of camber, a favorable stress distribution of the profile particles in the tire contact patch is established. In the case of multi-track vehicles such as commercial vehicles, the basic camber and camber variation are used for partial compensation of the camber angle with respect to the road, which arises at the outer wheel in a bend as a result of the rolling tendency of the vehicle. In the case of single wheel suspensions, the camber-depending on the axle principle and the kinematics of the axle-changes over the spring travel. By contrast, in the case of rigid axles, the camber with respect to the road remains approximately constant when cornering. In the case of an axle structure in which a conventional axle tube has been replaced by an axle bridge which is arranged at a certain offset from the wheel axis, camber variations arise in turn at the wheels on account of the offset of the axle bridge with respect to the wheel axis when there is a change in the payload or during cornering and unilateral deflection or rebounding movements of the wheels, these camber variations being caused by torsional movements in the link arms and/or the axle bridge. In an axle structure for a driven axle, in which there is no conventional axle tube and the connection of the pivotable link arms to the driven wheels fastened thereto is established via an axle bridge offset from the wheel axis, additional guidance of the wheels and a solution for transmitting the wheel forces is therefore necessary. In the design of axle structures for commercial vehicles, in particular including in air-sprung axle structures, it is also important to appropriately dissipate the lateral forces that arise. In particular when cornering or when there is an increase in the payload, the axial bridge is strongly subjected to bending load. This is true in particular even in the case of driven axles in a vehicle.

The first setting of the camber of the wheels to a value on mounting the axle structure on a commercial vehicle and the maintenance of a desired wheel camber of the driven wheels while the commercial vehicle is being driven and the transmission and compensation of the wheel forces that arise while the commercial vehicle is being driven is now possible via the suspension struts, which can be connected to the axle bridge via the fastening bracket. In order to keep the wheels at a desired camber angle and to cushion the forces that arise while the commercial vehicle is being driven, the fastening bracket is formed in the central region of the axle bridge. Suspension struts connected at their second end to one of the link arms can be fastened at their first end to the fastening bracket. When cornering and when carrying a high payload, the suspension struts fastened at a first end to the fastening bracket introduce the bending forces acting on the axle bridge into the link arms, to which the wheel carriers and the driven wheels are fastened. The attachment of the axle bridge to the link arms is subjected to less load as a result. The link arms dissipate the forces acting on them from the suspension struts to the wheels and the vehicle frame.

According to one configuration of the invention, the fastening bracket is in the form of a projection which is beneath the upper edge of the axle bridge and extends in a direction transverse to the direction of extent of the axle bridge, wherein the suspension struts have a length adjustment device and fastening elements for fastening suspension struts are formed on the projection and have a direction of tension which, when viewed from above, is at an angle <45° and >0° with respect to the direction of extent of the axle bridge.

The projection allows the suspension struts to act on the axle bridge at a lower level than the upper side of the axle bridge. Via the longer lever that is permitted as a result, the suspension struts can absorb higher forces.

The suspension struts have a length adjustment device. The suspension struts make it possible to set the camber of the wheels, the toe of the wheels, the inclination of the wheels and the caster of the corresponding axle structure to a desired value after the axle structure has been fitted on a commercial vehicle. The suspension struts may have a fixed length appropriate for a desired geometric setting of the wheels. However, it is also possible to make the geometric setting of the wheels settable by setting the length of the suspension struts to an appropriate length using the length adjustment device. The length may be adjusted for example by way of telescopic tubes that are fixable in a respective extension position, by way of a tensioning screw that can be set with a variable length or by way of other suitable length adjustment devices. The length of the suspension struts which are provided with a length adjustment device can be set to a desired value not only when mounting the axle structure on a vehicle, but also retrospectively while the vehicle is being used.

Owing to a direction of tension of the suspension struts, their direction of tension, when viewed from above, is at an angle <45° and >0° with respect to the direction of extent of the axle bridge. The direction of tension of the fastening elements in the specified angular range can be oriented by the fastening elements being accordingly oriented obliquely to a retaining plate to which the fastening elements are fastened, and/or the retaining plate to which the fastening elements are fastened is arranged in an angular position with respect to the direction of extent of the axle bridge, resulting in the specified angle of the direction of tension. As a result of a direction of tension of the suspension struts, which, when the axle bridge is viewed from above, are oriented at an angle <45° to the direction of extent of the axle bridge, a respective suspension strut, that portion of the axle bridge that is braced by the respective suspension strut, and the portion of the link arm between its attachment to the axle bridge and the point at which the respective suspension strut acts on the link arm form a triangle of forces via which the forces acting on these components are readily distributed. As a result, the suspension struts can effectively support the axle bridge in a direction transverse to the direction of longitudinal extent of the vehicle, and keep the wheels in a desired geometric setting when the commercial vehicle is being driven. Since the angle is >0°, the suspension struts can transmit not only transverse forces but also longitudinal forces from the axle bridge to the vehicle frame. The fasteners may for example be in the form of threaded bolts onto which a suspension strut can be screwed. However, it is also possible to provide hook-like fasteners or fasteners formed in another suitable way.

According to one configuration of the invention, fastening elements for fastening suspension struts are formed on opposite sides of the projection, at least one respective suspension strut being rotatably and/or articulatedly connected to the associated fastening element(s), on each side of the projection, at the fastening elements, and this suspension strut extends from the associated fastening element, when the axle structure is mounted and inactive in a commercial vehicle, to a point of attachment of the suspension strut to the link arm associated with this suspension strut, at an angle which deviates from the direct line between the associated fastening point and the center in the associated wheel by an angular dimension. As a result of the fastening elements being arranged on opposite sides of the projection, it is possible to transmit the transverse forces that act on the axle structure when the vehicle is cornering to both sides of the vehicle frame. Depending on the direction of action of a transverse force, the fastening elements arranged on a first side of the projection are subjected to tensile load and the fastening elements arranged on the second side of the projection are subjected to compressive load. The transverse forces being introduced into the vehicle frame on both sides results in very good support of the axle structure during cornering.

In each case at least two suspension struts may be arranged on each side of the projection that connect the projection from a respective fastening element to an associated link arm, and the suspension struts are oriented such that the first of the two suspension struts deviates upwardly, toward the link arm, from the direct line between the associated fastening point and the center in the associated wheel, and the second of the two suspension struts deviates downwardly, toward the link arm, from the direct line between the associated fastening point and the center in the associated wheel. In this specific arrangement, the at least two suspension struts each move, upon deformations of the link arms and of the axle bridge, in opposite directions, with the result that they generate a tilting moment on the respective link arm and thus also on the wheel fastened thereto. This tilting moment can be used to keep the wheel in a desired geometric setting during deflection or rebounding movements of the link arm.

According to one configuration of the invention, a fastening element for attaching a toe management device is formed on the axle bridge. By contrast to the suspension struts, the purpose of the toe management device is to favorably influence the toe of the wheels of the axle structure when the commercial vehicle is being driven. The toe of the wheels can change owing to different extents of the deflection and rebounding movements of the link arms on opposite sides of the vehicle frame, owing to torsional movements of the vehicle frame and owing to transverse forces introduced by the wheels. The vehicle equipped with the axle structure could as a result exhibit an intrinsic steering behavior which is disadvantageous for safe driving behavior. Moreover, the torques induced by the drive destabilize the consistency of the toe of the axle structure, in particular whenever the joints of the link arms are soft. This condition makes a toe management device necessary. Commercial vehicle chassis can also be set to different ground clearances. For this, the toe management device used must be configured such that it can ensure a straight toe of the axle structure for a very wide range of ground clearances. To solve these difficulties, a fastening element for attaching a toe management device is provided on the axle bridge. The fastening element for attaching a toe management device is preferably in the middle of the axle bridge, in order to be able to uniformly transfer forces introduced into the axle bridge by the toe management device to both sides of the axle structure and to be able to ensure a wide range of ground clearances of the axle structure.

According to one configuration of the invention, the fastening element is a shaft for connection to a Watt linkage. The rotatable joint of the Watt linkage can be placed on the shaft. In the case of a Watt linkage, the axis always remains guided centrally in the vertical direction during deflection and rebounding. It uses the effect described by the Watt parallelogram. The transverse struts are fixed to the frame on one side. The other movable ends are connected to the axle via a rotatable joint. The lateral stroke movements are a result of the radius traversed by the movable ends of the two transverse struts during deflection and rebounding. However, they do not draw the axis outward, because the rotatable joint allows the length compensation and thus keeps the axis in the center.

According to one configuration of the invention, the fastening element for attaching a toe management device is arranged on the opposite side of the axle bridge from the fastening bracket for attaching suspension struts. The arrangement of these components on opposite sides of the axle bridge results in a parallelogram-like distribution of force. The forces introduced by the suspension struts and the toe management device into the axle bridge are each introduced into the axle bridge optimally. Furthermore, the axle bridge being higher up makes it possible to position the fastening element for the toe management device in a region that is selected such that a collusion of the rotatable joint with the underlying surface is avoided.

It should be noted that the configurations of the invention that are set out above can each be combined separately, but also among one another with the subject matter of claim 1 and the rest of the dependent claims, as long as this is not prevented by any technical obstacles and there are no obligatory dependences.

Further modifications and configurations of the invention can be gathered from the claims, the description and the drawings.

The invention will be explained in more detail in the following text with reference to an exemplary embodiment.

In the figures:

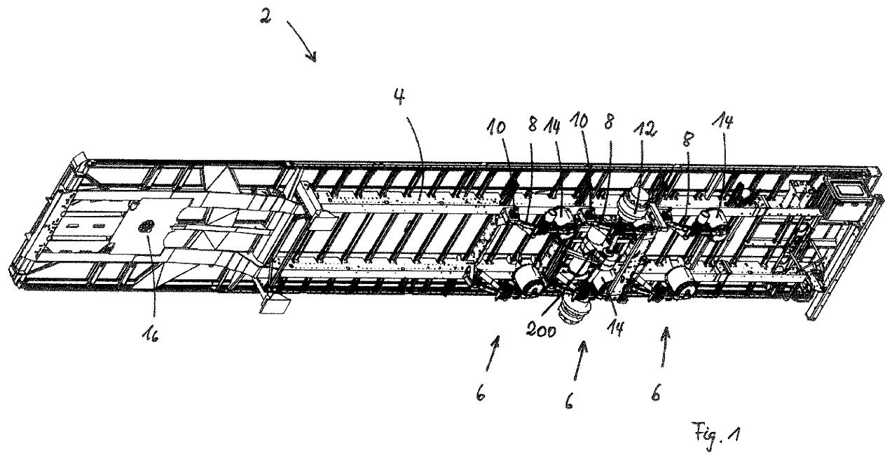

FIG. 1: shows an overall view, obliquely from below, of an electric drive train installed in a commercial vehicle,

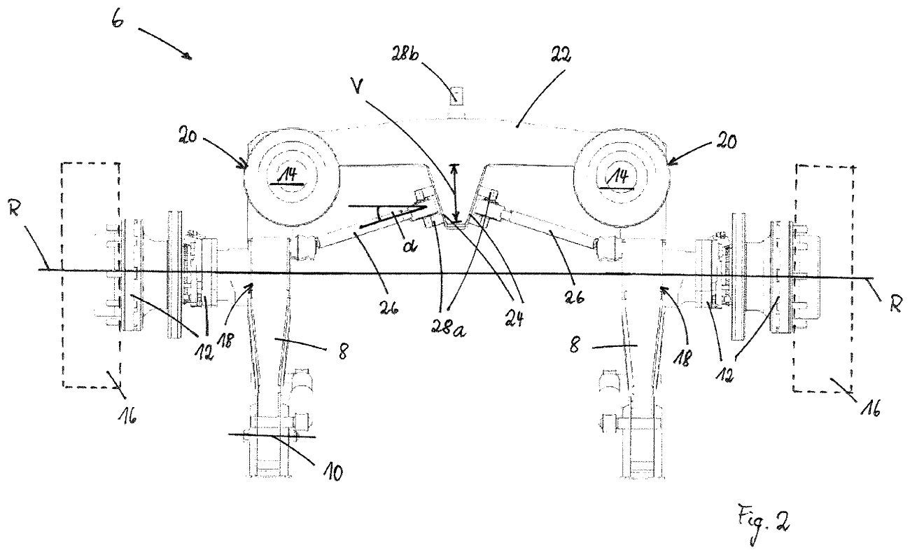

FIG. 2: shows a top view of the axle structure,

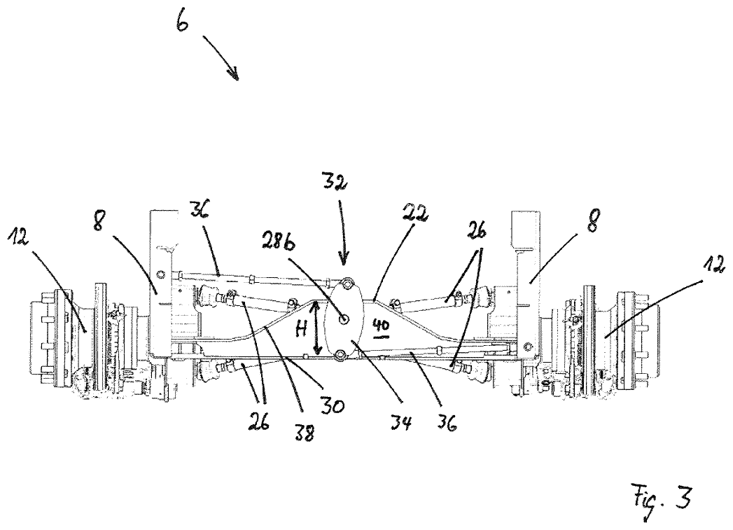

FIG. 3: shows a rear view of the axle structure,

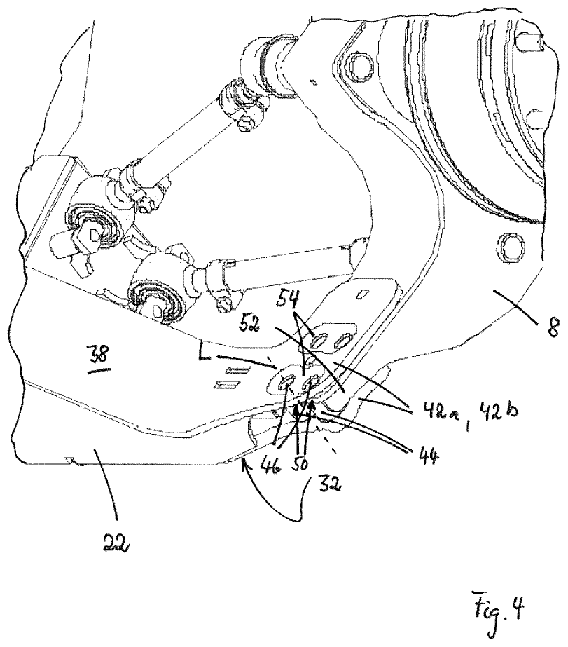

FIG. 4: shows an enlarged illustration of an outer end of the axle bridge, and

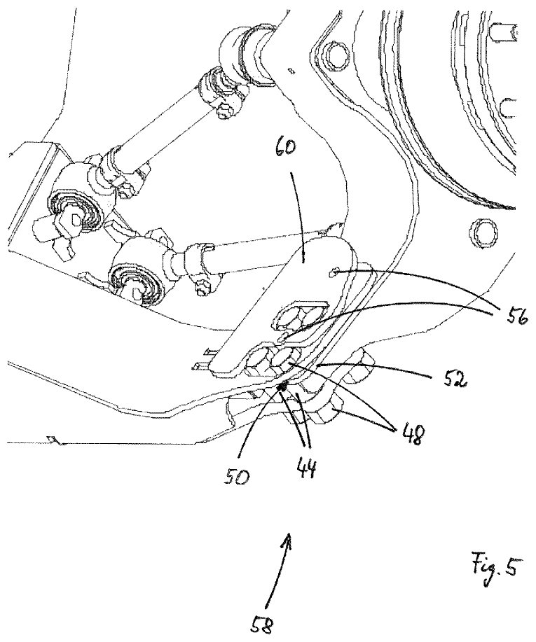

FIG. 5: shows the illustration, shown in FIG. 4, of an outer end of the axle bridge with a screw connection.

FIG. 1 shows an overall view, obliquely from below, of a commercial vehicle 2 in the form of a truck trailer, in which an electric drive train 200 is installed. The commercial vehicle 2 has a vehicle frame 4, which is supported on the ground via three axle structures 6 in the exemplary embodiment. The central axle structure 6 has the electric drive train 200, and the axle bridge and the axle have been omitted from the two other axle structures in order to simplify the drawing. In the front region, the commercial vehicle is placed by way of the kingpin K on the semitrailer coupling of a semitrailer truck, not illustrated in more detail in the drawing, and hauled via the latter.

The axle structures 6 each have, on opposite sides of the vehicle frame 4, a link arm 8, each of which is connected to the vehicle frame 4 via a pivot bearing 10 arranged in a retaining bracket. Also fastened to each link arm 8 is a wheel carrier 12, on which the wheels of the commercial vehicle 2 can then be screwed. At their end remote from the pivot bearing 10, the link arms 8 are also each supported on the vehicle frame 4 via a spring element 14. The link arms 8 thus rotate about the pivot bearing 10 in the event of spring movements and spring counter to the restoring forces in the flexible spring elements 14.

FIG. 2 shows a top view of the axle structure 6. Readily apparent in this view is the wheel axis R, the spatial position of which is determined by axes of rotation of at least two wheels 16 arranged on opposite sides of the axle structure 6. The wheels 16 are each held via a wheel carrier 12 on a link arm 8 connected thereto. The link arms 8 are spaced apart from one another along the wheel axis R and are each oriented in a direction transverse to the wheel axis R. The link arms 8 each have a pivot bearing 10 at a first end, an interface 18, at a first spacing from the pivot bearing 10, for attaching a wheel carrier 12 to the respective link arm 8, and a support portion 20, at a second spacing from the pivot bearing 10, for connecting the respective link arm 8 to a spring element 14.

The link arms 8 are connected to one another via an axle bridge 22 on that side of the wheel axis R that faces away from the pivot bearings 10. The link arms 8 are also connected to the axle bridge 22 in the region of the support portion 20 for connecting the respective link arm 8 to a spring element 14. A fastening bracket 24 for attaching suspension struts 26 is formed in the central region of the axle bridge 22. In the exemplary embodiment shown, the fastening bracket 24 is in the form of a projection V which is beneath the upper edge of the axle bridge 22 and extends in a direction transverse to the direction of extent of the axle bridge 22. Fastening elements 28a for fastening suspension struts 26 are formed on the projection V and have a direction of tension which, when viewed from above, is at an angle α<45° and >0° with respect to the direction of extent of the axle bridge 22.

Fastening elements 28a for fastening suspension struts 26 are formed on opposite sides of the projection V, at least one respective suspension strut 26 being rotatably and/or articulatedly connected to the associated fastening element(s) 28a, on each side of the projection V, at the fastening elements, and this suspension strut 26 extends from the associated fastening element 28a, when the axle structure 6 is mounted and inactive in a commercial vehicle, to a point of attachment of the suspension strut 26 to the link arm 8 associated with this suspension strut 26, at an angle which deviates from the direct line between the associated fastening point and the center in the associated wheel 16 by an angular dimension.

FIG. 3 shows a rear view of the axle structure. It is apparent from the view that the axle bridge 22 is in the form of a box-like welded structure with a base plate 30, a cover plate 38 and two side plates 40. The base plate 30 on the underside of the axle bridge 22 extends across the width of the axle bridge 22 in an at least approximately constant plane. The side plate 40 and thus the axle bridge 22 have a greater overall height H in their central portion than in the outer peripheral regions. A fastening element 28b for attaching a toe management device 32 is formed on the axle bridge 22. In the exemplary embodiment, the toe management device 32 is in the form of a Watt linkage. The fastening element 28b is a shaft, onto which the articulated plate 34 has been rotatably placed. By way of the articulated plate 34, the internal ends of the two transverse struts 36 are connected via pivot joints. The outer ends of the transverse struts 36 are each connected to a link arm. Via the Watt linkage, a tilting movement of a link arm 8 in a direction transverse to the direction of travel is transmitted to the other link arm 8.

It is apparent from FIG. 4, by way of an enlarged illustration of an outer end of the axle bridge 22, that this end has two plates 42a, 42b which are spaced apart from one another and, when the axle structure 6 has been mounted on a vehicle 2, are oriented at least approximately horizontally. Fixedly connected to the first plate 42a is at least one sleeve 44, the longitudinal center axis L of which, which is illustrated by a dashed line in FIG. 4, extends in an at least approximately vertical direction when the axle structure 6 has been installed in a vehicle 2. The two plates 42a, 42b have, in the continuation of the longitudinal center axis L of the sleeve 44, a passage opening 46 through which a threaded bolt 48 that fits into the sleeve 44 can be guided. Formed between the two plates 42a, 42b and one end of the sleeve 44 is an intermediate space 50 in which a connecting element 52 of a link arm 8 is inserted. The connecting element 52 of the link arm 8 likewise has, in the continuation of the longitudinal center axis L of the sleeve 44, a passage opening 46 through which the threaded bolt 48 that fits into the sleeve 44 is guided, as is shown in FIG. 5. In the exemplary embodiment, the two sides, facing away from the sleeve 44, of the two plates 42a, 42b have a clamping surface 54 against which a threaded nut or a head of the threaded bolt 48 is screwed. If a threaded bolt 48 has been screwed to a threaded sleeve 44 welded on the inner side of one of the two plates 42a, 42b, it is sufficient, of course, for only the plate 42a, 42b that is not welded to the threaded sleeve 44 to have a clamping surface 54.

FIG. 5 also shows that the axle bridge 22 has, at the outer end illustrated therein, a fastener for connecting to an air-spring bellows as an example of a spring element 14. In the exemplary embodiment shown, the fastener is the two threaded holes 56, via which an air-spring bellows can be screwed to the axle structure 6. That end of the axle bridge 22 that is illustrated in FIGS. 4 and 5 forms, together with the two plates 42a, 42b and the connecting element 52, a connection node 58, via which the axle bridge 22 is connected both to the link arm 8 and to the air-spring bellows. In the exemplary embodiment, a bellows carrier 60 has been placed on the upper of the two plates 42a, 42b that are located at one end of the axle bridge 22 and has been fixedly connected to the axle bridge 22.

The invention is not restricted to the above-described exemplary embodiment. A person skilled in the art will have no difficulty in modifying the exemplary embodiment in a way that appears to be suitable to them in order to adapt it to a specific application.

### LIST OF REFERENCE SIGNS

2 Commercial vehicle
4 Vehicle frame
6 Axle structure
8 Link arm
10 Pivot bearing
12 Wheel carrier
14 Spring element
16 Wheel
18 Interface for attaching a wheel carrier
20 Support portion
22 Axle bridge
24 Fastening bracket
26 Suspension struts
28 Fastening element
30 Base plate
32 Toe management device
34 Articulated plate
36 Transverse strut
38 Cover plate
40 Side plate
42 Plate
44 Sleeve
46 Passage opening
48 Threaded bolt
50 Intermediate space
52 Connecting element
54 Clamping surface
56 Threaded hole
58 Connection node
60 Bellows carrier
200 Electric drive train
K Kingpin
R Wheel axis
V Projection
L Longitudinal center axis

1. An axle structure (6) for a commercial vehicle chassis, having a wheel axis (R), the spatial position of which is determined by axes of rotation of at least two wheels (16) located on opposite sides of the axle structure (6), the wheels (16) are each held, via a wheel carrier (12), on a link arm (8) connected to the wheel carrier, the link arms (8) are spaced apart from one another along the wheel axis (R) and are each oriented in a direction transverse to the wheel axis (R), the link arms (8) each have a pivot bearing (10) at a first end, an interface (18), at a first spacing from the pivot bearing (10), for attaching a wheel carrier (12) to the respective link arm (8), and a support portion (20), at a second spacing from the pivot bearing (10), for connecting the respective link arm (8) to a spring element (14), characterized in that the link arms (8), on that side of the wheel axis (R) that faces away from the pivot bearings (10), are connected to one another via an axle bridge (22), wherein the axle bridge (22) is screwed to the link arms (8).

2. The axle structure as claimed in claim 1, characterized in that the outer ends of the axle bridge (22) have two plates (42a, 42b) which are spaced apart from one another and, when the axle structure (6) has been mounted on a vehicle (2), are oriented at least approximately horizontally, wherein between the two plates (42a, 42b) there is at least one sleeve (44), the longitudinal center axis (L) of which, when the axle structure (6) has been installed in a vehicle (2), extends in an at least approximately vertical direction, at least one of the two plates (42a, 42b) having, in the continuation of the longitudinal center axis of the sleeve (44), a passage opening (46) through which a threaded bolt (48) that fits into the sleeve (44) is guided, formed between the two plates (42a, 42b) and one end of the sleeve (44) is an intermediate space (50) in which a connecting element (52) of a link arm (8) is inserted, the connecting element (52) of the link arm (8) also having, in the continuation of the longitudinal center axis of the sleeve (44), a passage opening (46) through which the threaded bolt (48) that fits into the sleeve (44) is guided, and at least that side of one of the two plates (42a, 42b) that faces away from the sleeve (44) has a clamping surface (54), against which a threaded nut or a head of the threaded bolt (48) is screwed.

3. The axle structure as claimed in claim 2, characterized in that the axle bridge (22) is in the form of a welded structure and the plates (42a, 42b) are outwardly facing extensions of the upper and lower profile limbs, in particular of the base plate (30) and of the cover plate (38), of the axle bridge (22).

4. The axle structure as claimed in claim 1, characterized in that the plates (42a, 42b), when viewed from above, have their longitudinal center axes angled toward the wheel axis (R) in comparison with the longitudinal center axis of the rest of the axle bridge (22).

5. The axle structure as claimed in claim 1, characterized in that the axle bridge (22) at its outer ends has a respective fastener for connection to an air-spring bellows.

6. The axle structure as claimed in claim 5, characterized in that a corresponding end of the axle bridge (22) is connected both to the link arm (8) and to the air-spring bellows at a connection node (58).

7. The axle structure as claimed in claim 2, characterized in that a bellows carrier (60) has been placed on the upper of the two plates (42a, 42b) that are located at one end of the axle bridge (22) and has been fixedly connected to the axle bridge (22).

8. The axle structure as claimed in claim 1, characterized in that the connection between the axle bridge (22) and the link arm (8) is configured such that it is possible to mount a spring element (14) on at least one of these elements without needing to detach the connection between the axle bridge (22) and the link arm (8).

9. The axle structure as claimed in claim 1, characterized in that the axle bridge (22) is in the form of a welded structure which on its underside has a base plate (30), which extends across the width of the axle bridge (22) in an at least approximately constant plane and has a greater overall height (H) in its central portion than in the outer peripheral regions.

10. The axle structure as claimed in claim 1, characterized in that a fastening bracket (24) for attaching suspension struts (26) is formed in the central region of the axle bridge (22).

11. The axle structure as claimed in claim 10, characterized in that the fastening bracket (24) is in the form of a projection (V) which is beneath the upper edge of the axle bridge (22) and extends in a direction transverse to the direction of extent of the axle bridge (22), wherein fastening elements (28a) for fastening suspension struts (26) are formed on the projection (V) and have a direction of tension which, when viewed from above, is at an angle (α) <45° and >0° with respect to the direction of extent of the axle bridge (22).

12. The axle structure as claimed in claim 11, characterized in that fastening elements (28a) for fastening suspension struts (26) are formed on opposite sides of the projection (V), at least one respective suspension strut (26) being rotatably and/or articulatedly connected to the associated fastening element(s) (28a), on each side of the projection (V), at the fastening elements, and this suspension strut (26) extends from the associated fastening element (28a), when the axle structure (6) is mounted and inactive in a commercial vehicle, to a point of attachment of the suspension strut (26) to the link arm (8) associated with this suspension strut (26), at an angle which deviates from the direct line between the associated fastening point and the center in the associated wheel (16) by an angular dimension.

13. The axle structure as claimed in claim 1, characterized in that a fastening element (28b) for attaching a toe management device (32) is formed on the axle bridge (22).

14. The axle structure as claimed in claim 13, characterized in that the fastening element (28b) is a shaft for connection to a Watt linkage.

15. The axle structure as claimed in claim 1, characterized in that the fastening element (28b) for attaching a toe management device (32) is arranged on the opposite side of the axle bridge (22) from the fastening bracket (24) for attaching suspension struts (26).

16. A commercial vehicle (2) which has an axle structure (6) for a commercial vehicle chassis, having a wheel axis (R), the spatial position of which is determined by axes of rotation of at least two wheels (16) located on opposite sides of the axle structure (6), the wheels (16) are each held, via a wheel carrier (12), on a link arm (8) connected to the wheel carrier, the link arms (8) are spaced apart from one another along the wheel axis (R) and are each oriented in a direction transverse to the wheel axis (R), the link arms (8) each have a pivot bearing (10) at a first end, an interface (18), at a first spacing from the pivot bearing (10), for attaching a wheel carrier (12) to the respective link arm (8), and a support portion (20), at a second spacing from the pivot bearing (10), for connecting the respective link arm (8) to a spring element (14), characterized in that the axle structure is designed as claimed in the characterizing features of claim 1.
